(19) United States
(12) Patent Application Publication
(10) Pub. No.: US 2009/0231610 A1
(43) Pub. Date: Sep. 17, 2009

(54) ARRANGING PRINT JOBS FOR PERFECT BOUND IMPOSITION

(76) Inventor: Orly L. Frank, Herzlia (IL)

Correspondence Address: David A. Novais;Patent Legal Staff, Eastman Kodak Company, 343 State Street, Rochester, NY, 14650-2201, US

(21) Appl. No.: 12/047,576

(22) Filed: Mar. 13, 2008

(51) Int. Cl. G06F 15/00

(52) U.S. Cl. 358/1.15

(57) ABSTRACT

A method for arranging print job pages for printing by a digital printer and finished in a prefect bound manner including preparing the print job pages (20) into a form ready for consumption by a digital printer. A first portion of the pages for volume printing (15) and a second portion of the pages for cover printing (17) are marked. The first portion is marked to form a first series of pages conforming to perfect bound imposition scheme (21). The second portion is prepared to form a second series of pages conforming to a second imposition scheme (33). The first series of pages to the digital printer equipped with finisher equipment, and the second series of pages are delivered to the digital printer.

### FIELD OF THE INVENTION

The present invention relates to methods for arranging a composed printing job in accordance with complex printing and print finishing capabilities and more specifically for achieving efficient perfect binding.

### BACKGROUND OF THE INVENTION

Print jobs are currently prepared in desktop publishing (DTP) to support the requirements of printing machinery. In other words, the files prepared in the DTP are usually delivered to the digital front end (DFE) in a page description format (PDF). The delivered PDF is already designed to be printed correctly on the destination printing equipment, taking into consideration ahead of time aspects such as the printer's media handling and orientation factors.

In cases where the prepared printing job (represented by the delivered PDF) is redirected due to a last minute decision, for example, printing on different printing equipment than the original destination equipment, then the job must be redone in the DTP to conform to the alternative printing equipment.

Booklets are often prepared by casual users, typically using prominent DTP applications such as Microsoft Word. The casual users are often not aware of the characteristics of the printing equipment to be used for the requested booklet printing. Thus, it would be advantageous to decouple the printing equipment characteristics from the digital representation of the document to be printed, freeing up the job creator from the need to be aware of the printing equipment configuration.

### SUMMARY OF THE INVENTION

Briefly, according to one aspect of the present invention a method for arranging print job pages for printing by a digital printer and finished in a perfect bound manner includes preparing the print job pages in a print ready form for consumption by a digital printer; marking a first portion of the pages for volume printing and a second portion of the pages for cover printing; preparing the first portion to form a first series of pages conforming to perfect bound imposition scheme; preparing the second portion to form a second series of pages conforming to a second imposition scheme; delivering the first series of pages to a digital printer equipped with finisher equipment; and delivering the second series of pages to the digital printer.

These and other objects, features, and advantages of the present invention will become apparent to those skilled in the art upon a reading of the following detailed description when taken in conjunction with the drawings wherein there is shown and described an illustrative embodiment of the invention.

### BRIEF DESCRIPTION OF THE DRAWINGS

FIG. 1 is a schematic illustrating composed layout for a finisher;

FIG. 2 is a schematic illustrating duplex book printing with pre-printed cover and left binding imposition;

FIG. 3 is a schematic illustrating duplex book printing with composed duplex cover with content spine and left binding imposition;

FIG. 4 is a schematic illustrating duplex book printing with duplex pre-composed cover and left binding imposition;

FIG. 5 is a schematic illustrating duplex book printing with composed duplex cover with blank content spine and right binding imposition;

FIG. 6 is a schematic illustrating duplex book printing with duplex pre-composed cover including a Z-fold insert and left binding imposition;

FIG. 7 is a schematic illustrating duplex book printing with composed duplex cover with left binding imposition for personalized booklet printing;

FIG. 8 is a schematic illustrating duplex book printing with composed duplex cover with content spine with 180 degree rotation and left binding imposition;

FIG. 9 is a schematic illustrating duplex book printing with composed duplex cover with content spine, left binding imposition, and cover sheet remainder;

FIG. 10 is a schematic illustrating duplex book printing with composed duplex cover with content spine with 180 degree rotation, left binding imposition, and cover sheet remainder;

FIG. 11 is a schematic illustrating duplex book printing with composed duplex cover with content spine and left binding imposition with 180 degree rotation along the X-axis; and

FIG. 12 is a schematic illustrating 1×1 and 3×1 schemes.

### DETAILED DESCRIPTION OF THE INVENTION

The invention provides methods and apparatus for arranging components such as volume and cover pages, of a composed printing job, to be delivered to a digital printer coupled with a finishing device. The components will be delivered in optimal page order and orientation in order to produce complete, perfect bound books, or perfect bound personalized booklets. The correct orientation is achieved by rotating the pages to conform to the finishing device characteristics.

The rotation is dependent upon the print rotation needed by the destination printer to comply with the leading edge, back, and front rotation needs. The raster data is created and rotated in 90 degrees in accordance with the destination printer's raster data orientation and components order needs.

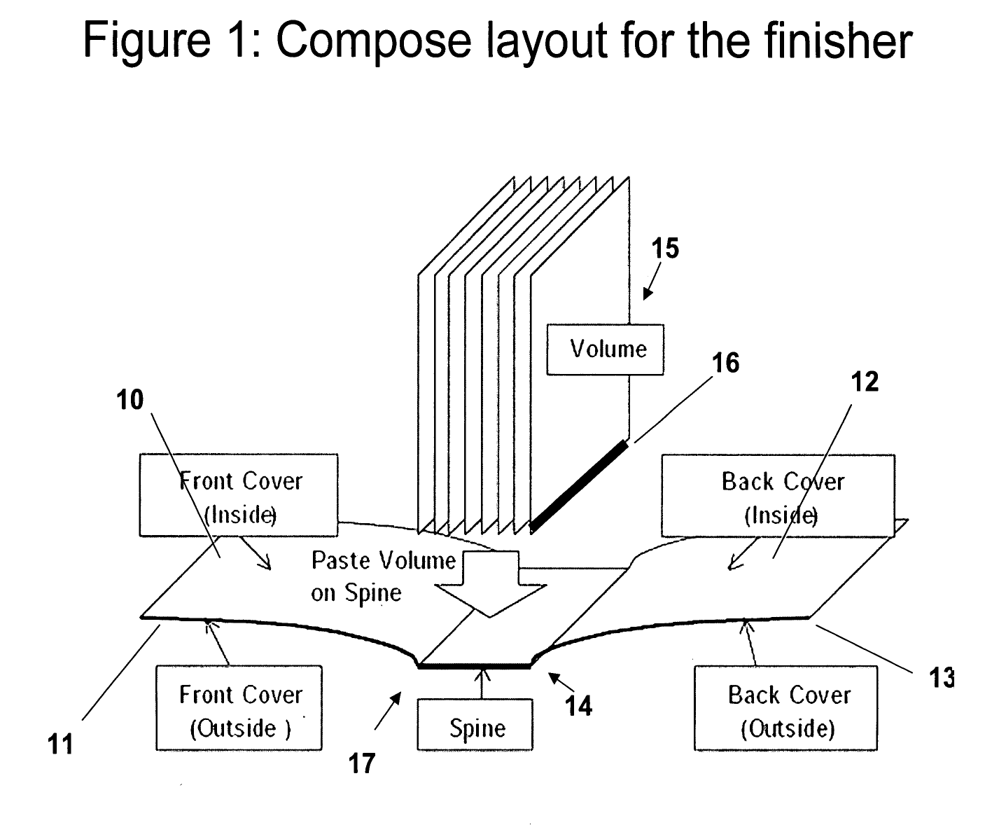

FIG. 1 shows the composed pages delivery order to conform to the capabilities of the finishing equipment. The cover is composed of the following components:
a) Front cover content inside 10 and outside 11.
b) Back cover content inside 12 and outside 13.
c) Spine content 14.
   The content of the components a), b), and c) described above are pasted onto a special cover page 17, often comprising a different material than the volume pages 15. Cover page 17 and volume pages 15 are fetched from different page trays from the printing device.

Volume pages 15 are delivered to the finisher in the correct orientation for applying glue direction 16 in the correct facet of the volume pages 15, so it is pasted on spine 14 matching glue direction 16. Page cover 17 is delivered to the finisher in the correct orientation to consume volume pages 15 in conformance with glue direction 16.

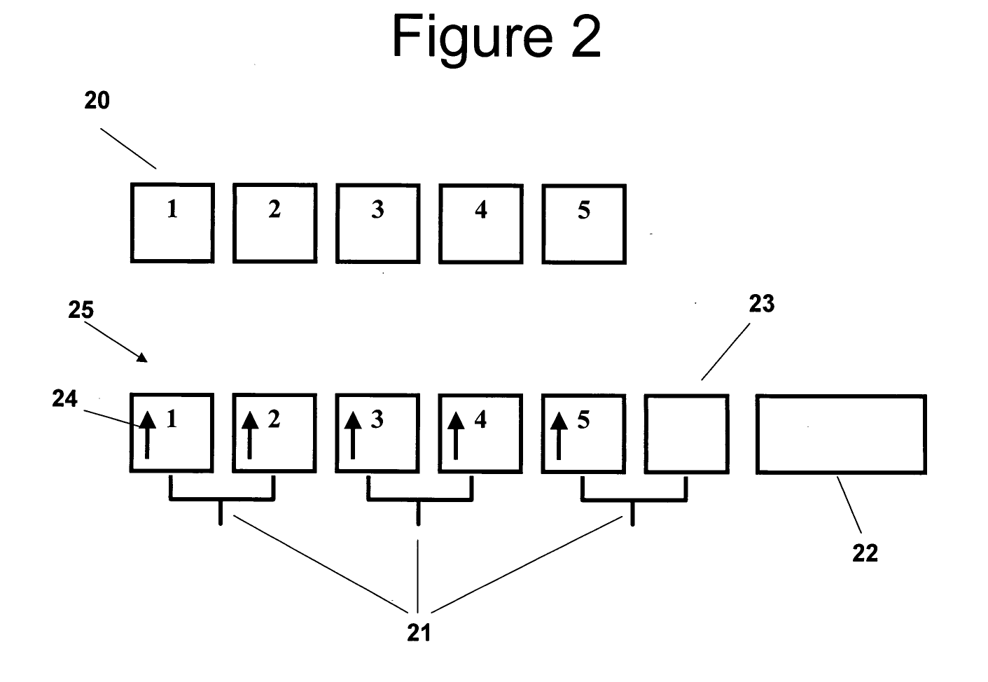

FIG. 2 depicts a printing scheme for a duplex book using a pre-printed cover 22 in a left binding manner. Left binding is used for Latin languages (written from left to right), whereas right binding scheme suites languages such as Hebrew and Arabic (written from right to left) and some Far East languages which often are viewed from right to left.

Pages are prepared by the originating application in pages application order 20. The pages are handed over to the finisher in the following output sequence 25, and in the correct orientation where the top of each page is indicated arrow 24. The volume pages 15 are imposed as duplex perfect bound imposition 21. The volume pages 15 are also rotated according to the glue direction 16 and user selected binding (left binding is used in FIG. 1), followed by a pre-printed cover 22 in a simplex form. This example depicts printing of five volume pages in duplex, meaning two pages per sheet. One page will be used for the front sheet and a second page for the back sheet. In this example three sheets are used for five volume pages, thus the back side page 23 of sheet three will be left blank.

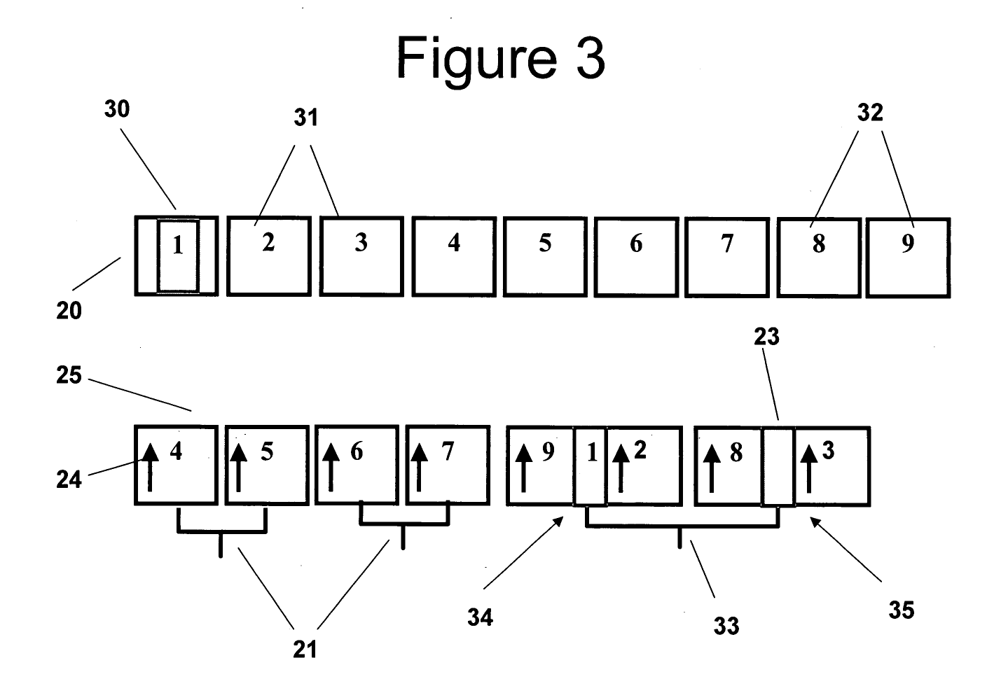

FIG. 3 depicts printing of a duplex book. The printing contains a composed cover using left binding. The cover is printed in duplex cover with the spine content 30. This example shows two different imposition schemes used in the same printing job, one for the volume pages 15 prepared for perfect binding imposition 21 and a saddle stitch imposition 33 scheme, which is applied for the cover content.

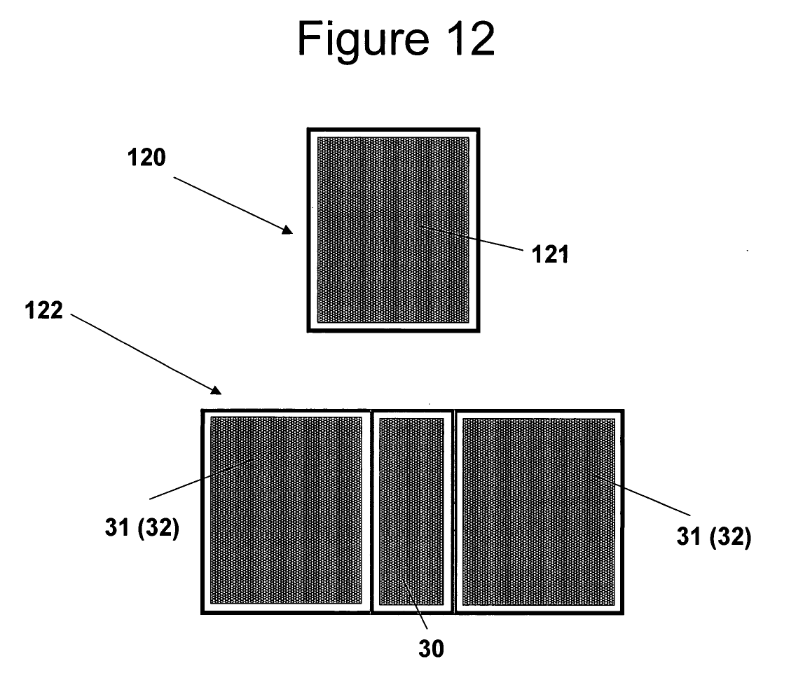

In the first scheme 21, the volume pages 15 are imposed in perfect bound 1×1 imposition (one content page imposed on one paper sheet). FIG. 12 further describes 1×1 imposition performed on a paper sheet side of content 120, where a single page content 121 is placed and centered on sheet side 120. The volume pages 15 are also rotated according to the glue direction 16 and a user selected binding is applied, in this case it is left binding, usually is used for languages read from left to right. The cover sheet 33 is imposed as saddle stitch 3×1 imposition (three content pages are imposed on one paper sheet), including three components: content spine 30, front cover pages 31 (front inside 10 and front outside 11) and back cover pages 32 (back inside 12 and back outside 13), to form a single ready to print cover sheet 33.

FIG. 12 further describes the 3×1 imposition. Given a sheet side for 3×1 imposition of content 122, where the following three components are placed and centered on sheet side 122: two cover pages (front 31 or back 32) and spine content 30. The cover sheet 33 and the volume pages 15 also rotated according to the glue location and user selected binding (left binding in this case). All the pages, composed cover page 33 and volume pages 15 are centered according to the destination output sheets.

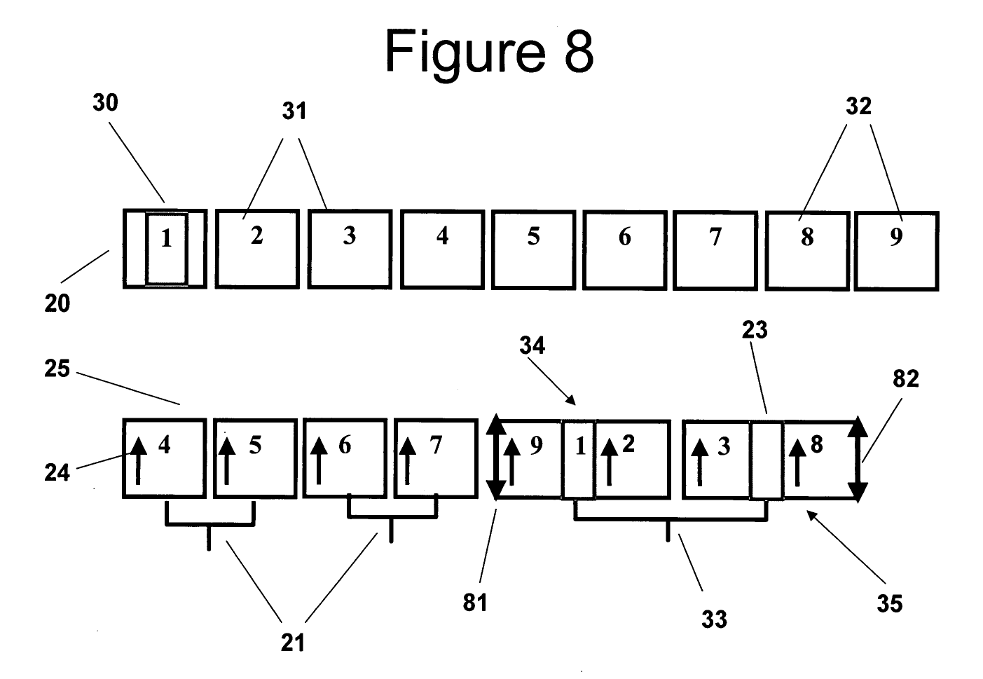

FIG. 8 describes an embodiment similar to the one depicted in FIG. 3. This embodiment supports printers with media front to back rotation degree of 180 relative to the Y axis (indicated by rotation guide 81) of the raster data. The composed front cover 34 should be rotated along the front cover rotation guide 81, before printing of the composed back cover 35 pages. The 180 degrees rotated composed front cover 34 is illustrated by the rotation guide position 82 as is shown on composed back cover 35 (after rotation is performed). All the pages, composed cover pages (34, 35) and volume pages 15 are centered according to the destination output sheet.

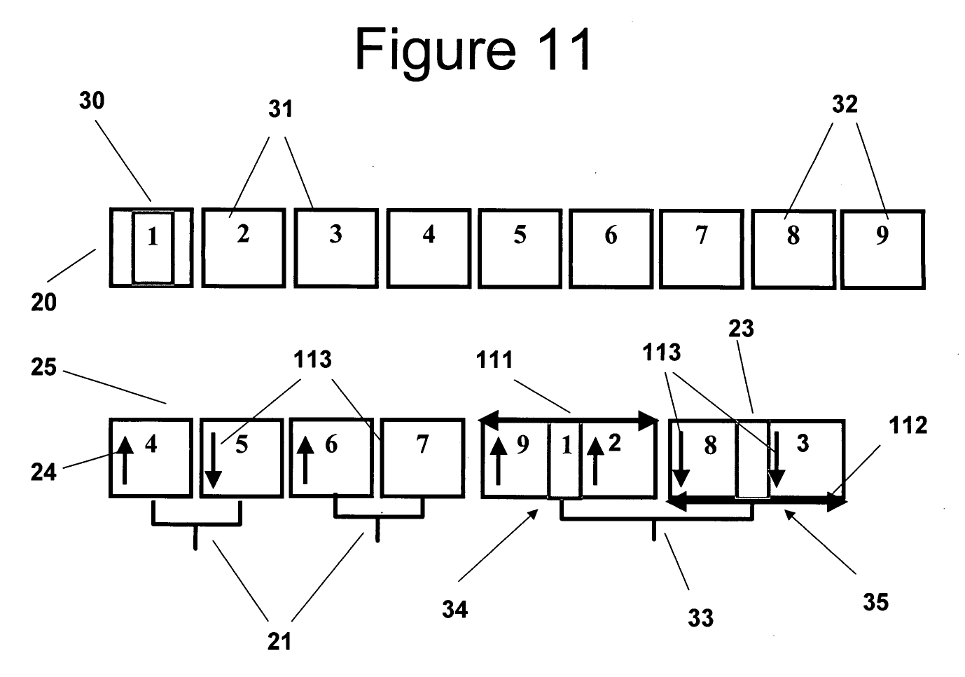

FIG. 11 describes another embodiment. This embodiment supports digital printers that rotate the printing sheets 180 degree along the X-axis (indicated by rotation guide 111) in order to print on the back side of the sheet, such as the Kodak Nexpress digital printer. Numeral 112 indicates the position of the sheet after rotation along the X-axis. In this case the page content printed on the back side of the paper sheets should be rotated by 180 degrees before printing to comply with the direction of content printed of the front side of the paper sheets, as is indicated by top page direction (rotated by 180 degrees) 113.

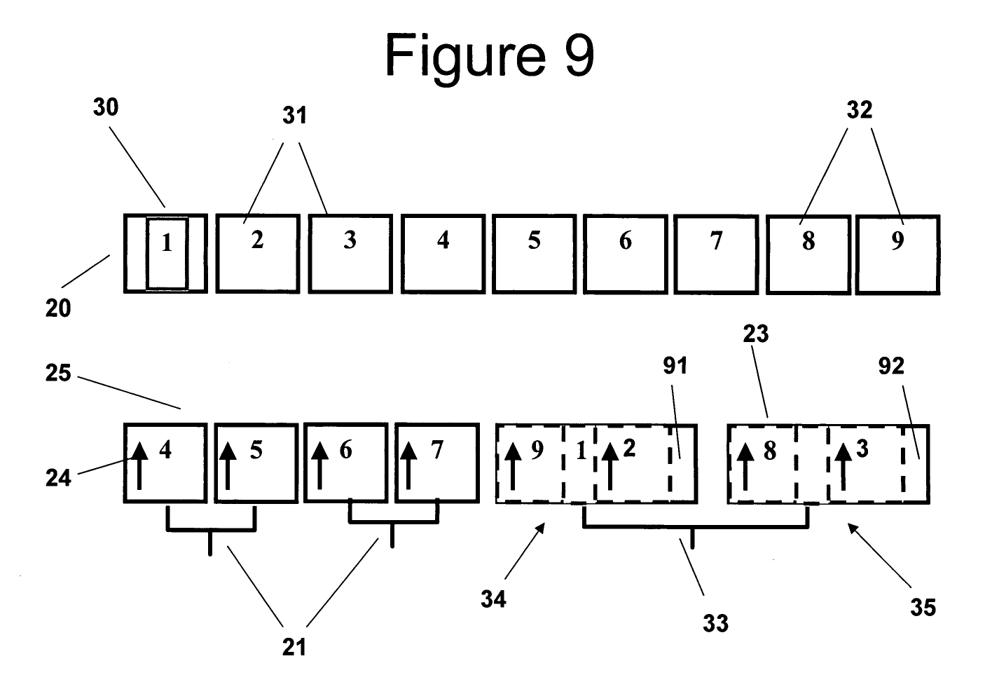

FIG. 9 describes an embodiment similar to the one depicted in FIG. 3. In this embodiment the volume pages are centered according to the output sheet whereas the composed front and back cover (34 and 35) include alignment to the opposite axis's of the page trimmer in the printing equipment.

The cover sheet 33 is imposed as saddle stitch 3×1 imposition, including three components: spine content 30, front cover pages 31, and back cover pages 32, to form a single ready to print cover sheet 33. In this embodiment the cover sheet 33 is larger than the described components (30, 31, 32) that are printed on cover sheet 33, thus leaving an unused portion of front and back cover sheet remainder (91, 92) to be further trimmed by the printing equipment trimmer.

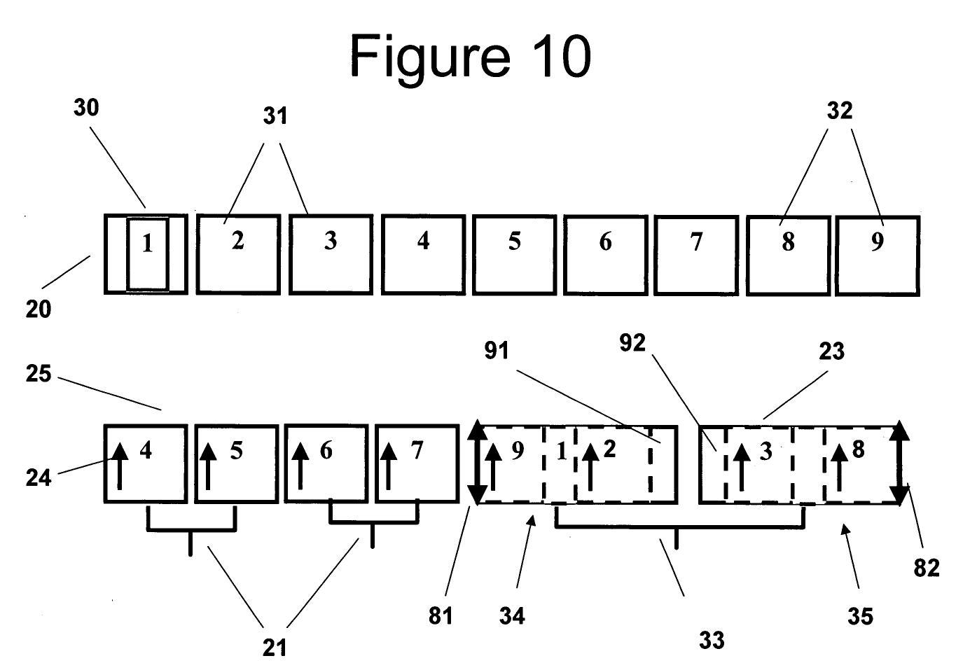

FIG. 10 describes an embodiment similar to the description pertaining to FIG. 9. This embodiment supports printers with media front to back rotation degree of 180 degrees relative to the Y axis of the raster data.

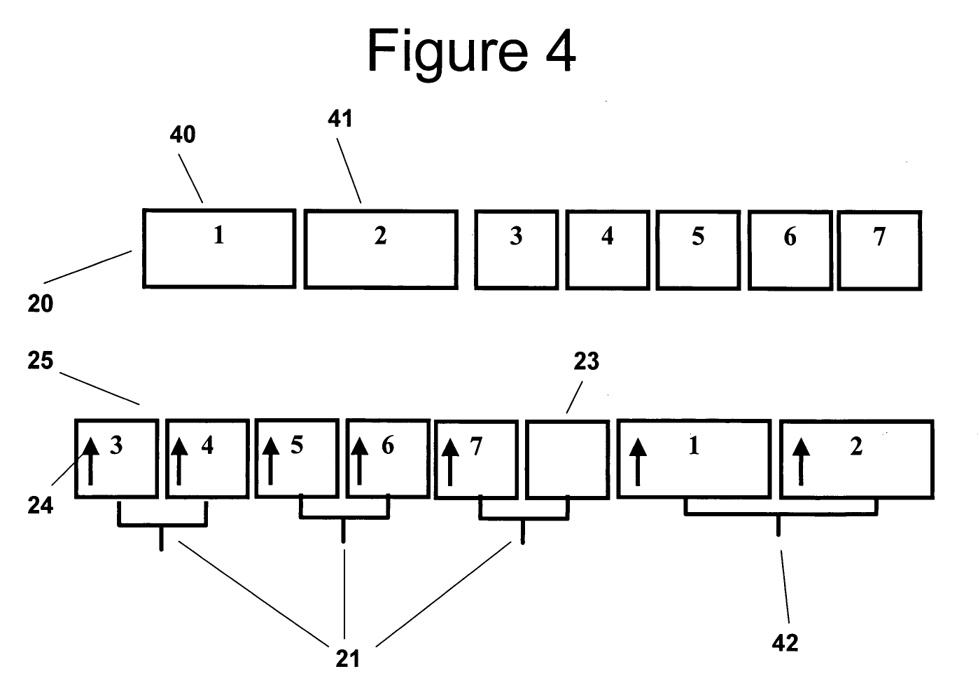

FIG. 4 depicts printing of a duplex book comprising a pre-composed cover using left binding. The volume pages 15 are rotated according to the glue location and the user elected binding, and imposed as perfect bound 1×1 imposition. The duplex cover 42 is imposed in “step and continue” 1×1 imposition manner. The pre-composed outside cover pages with spine content 40 and inside cover 41 cover are also rotated according to the glue direction 16 and user selected binding needs.

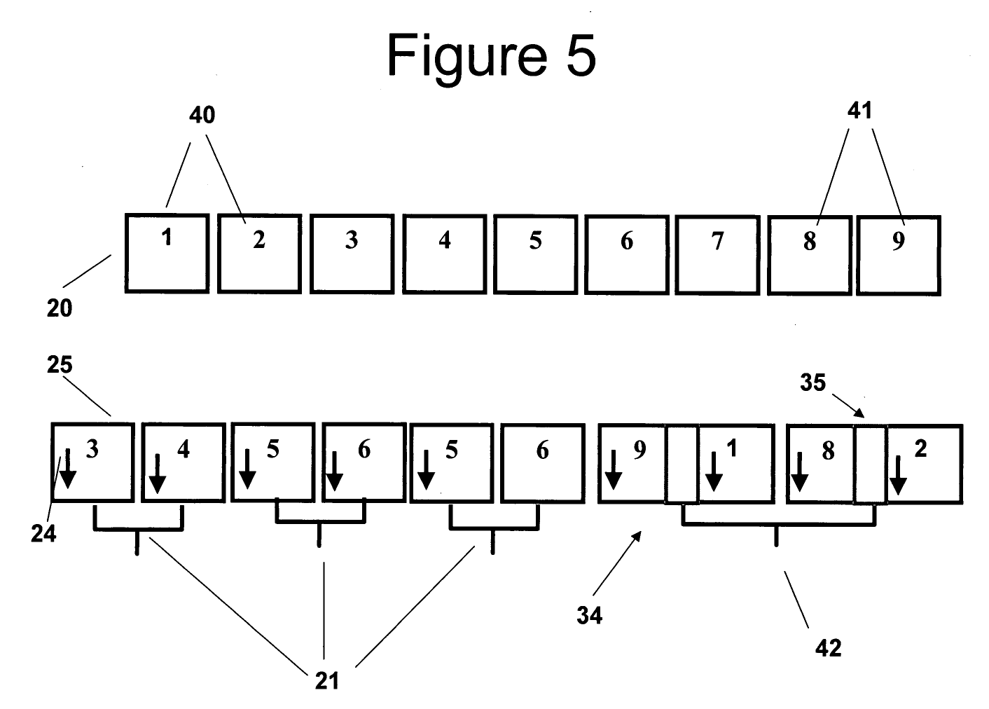

FIG. 5 depicts printing of a duplex book comprising a duplex cover with blank spine using right binding, suitable for Hebrew, Arabic, and Far East languages. The volume pages 15 are imposed as perfect bound 1×1 imposition. The volume pages are also rotated according to the glue direction 16 and right binding. The cover is imposed as saddle stitch 3×1 imposition including content spine 14. The cover sheet and pages also rotated according to the glue direction 16 and also made for right binding imposition.

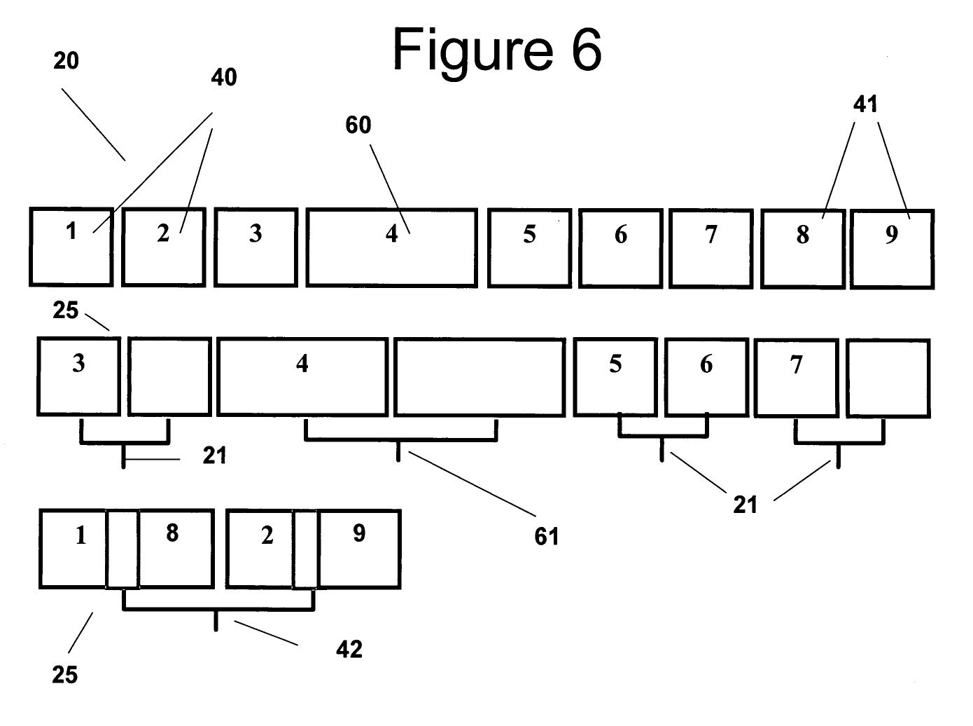

FIG. 6 depicts printing of a duplex book comprising a duplex cover including a z-fold element inserted between volume pages 15. This scheme will also include a blank spine, and will use left binding imposition. The z-fold element 60 is page 4 in the input sequence 20 in this example and the volume pages 15 are imposed as perfect bound 1×1 imposition. The volume pages also rotated according to the glue direction 16. The cover is imposed as saddle stitch 3×1 imposition including content spine 14. The cover sheet and pages also rotated according to the glue direction 16 using left binding imposition. All the pages, composed cover page 17, Z-fold 61, and volume pages 15 are centered according to the output sheet.

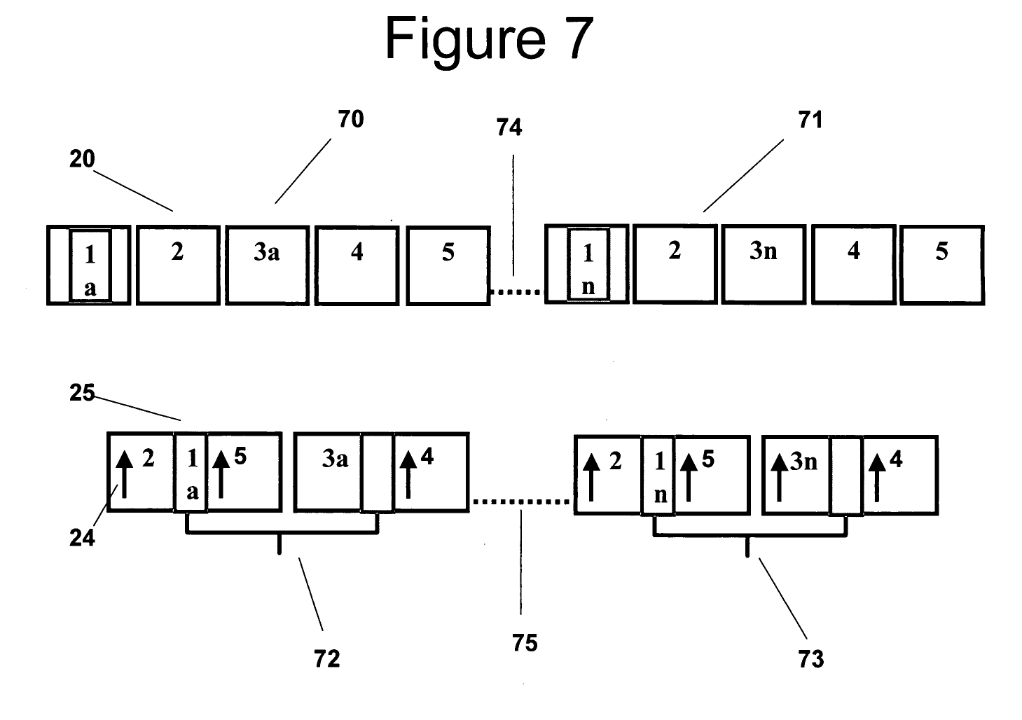

FIG. 7 shows a personalized booklet printing. The original page sequence 20 includes series of content for the personalized booklet. This example shows printing of plurality of booklets 70, 74, and 71, each including four pages and a spine 14. Some pages might and possibly the spine might differ from booklet to booklet, for example booklet 70 is different than booklet 71 both in the spine content and page 3. The pages are delivered arranged to conform to the digital printing and finishing devices in output form to produce a plurality of booklets 72, 75, and 73.

The invention has been described in detail with particular reference to certain preferred embodiments thereof, but it will be understood that variations and modifications can be effected within the scope of the invention.

### PARTS LIST

10 front cover inside
11 front cover outside
12 back cover inside
13 back cover outside
14 spine
15 volume pages
16 glue direction
17 cover page
20 original pages sequence (per application)
21 duplex pages in order for perfect binding
22 pre-printed cover in simplex
23 page left blank
24 top of page direction
25 output sequence
30 spine content (application order)
31 front cover pages (application order)
32 back cover pages (application order)
33 cover sheet saddle stitch imposition
34 composed front cover
35 composed back cover
40 pre-composed outside cover pages with spine content
41 pre-composed inside cover pages with spine content
42 duplex cover in order for finisher
60 z-fold at the input sequence
61 z-fold duplex at the output sequence
70 input booklet-1
71 input booklet-n
72 output booklet-1
73 output booklet-n
74 input booklet-2 . . . booklet (n−1)
75 output booklet-2 . . . booklet (n−1)
81 front cover rotation guide (Y-axis)
82 rotation guide position after front cover rotation (Y-axis)
91 front cover sheet remainder
92 back cover sheet remainder
111 front cover rotation guide (X-axis)
112 rotation guide position after front cover rotation (X-axis)
113 top page direction (rotated by 180 degrees)
120 sheet side for 1×1 imposition of content
121 single page content for 1×1 imposition
122 sheet side for 3×1 imposition of content

1. A method for arranging print job pages to be ready for printing by a digital printer and finished in a prefect bound manner comprising the steps of:
preparing said print job pages in a form ready for printing by said digital printer;
marking a first portion of said pages for volume printing and a second portion of said pages for cover printing;
preparing said first portion to form a first series of pages conforming to a perfect bound imposition scheme for volume printing;
preparing said second portion to form a second series of pages conforming to a second imposition scheme for cover printing;
delivering said first series of pages to said digital printer equipped with a finisher equipment; and
delivering said second series of pages to said digital printer.

2. The method of claim 1 further comprising:
marking at least one additional portion of said pages for special folded inserts pages;
preparing said at least one additional portion to form an additional imposition scheme; and
delivering said additional series of pages to said digital printer between said first series of pages and said second series of pages.

3. The method of claim 1 wherein said first series of pages is prepared in accordance with finisher requirements, page orientation, and glue location.

4. The method of claim 1 wherein said second series of pages is prepared in accordance with finisher requirements, page orientation, and glue location.

5. The method of claim 2 wherein said additional series of pages is prepared in accordance with finisher requirements, page orientation, and glue location.

6. The method of claim 1 wherein each of said first series of pages and said second series of pages are printed on media fetched from different page trays of the digital printer.

7. The method of claim 2 wherein said additional series of pages are printed on media fetched from different page trays of the digital printer as said first series of pages or said second series of pages.

8. The method of claim 1 wherein said first series of pages and said second series of pages are fetched from different page trays of the digital printer.

9. The method of claim 1 wherein said second imposition scheme is perfect bound imposition.

10. The method of claim 2 wherein said additional imposition scheme is perfect bound imposition.

11. The method of claim 1 wherein said print job pages are prepared for personalized booklet printing.

12. The method of claim 1 wherein said print job pages are prepared for left binding imposition.

13. The method of claim 1 wherein said print job pages are prepared for right binding imposition.
